(19) United States
(12) Patent Application Publication
(10) Pub. No.: US 2006/0287835 A1
(43) Pub. Date: Dec. 21, 2006

(54) Inspection system of structures and equipment and related method thereof

(76) Inventors: Pradip N. Sheth, Charlottesville, VA (US); Dominick T. Montie, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 11/184,448

(22) Filed: Jul. 19, 2005

Related U.S. Application Data
(60) Provisional application No. 60/589,113, filed on Jul. 19, 2004.

(51) Int. Cl. G01B 5/28

(52) U.S. Cl. 702/35

(57) ABSTRACT

An inspection system and method for use in conjunction with a movably mounted platform to perform inspections of a generally upright standing structures or underground/subsurface structure. In order to perform these inspections, a technician or user can mount an interface member and the detector on the platform and/or interface member. The platform can be moved along the length of the structure while the inspector/detector module captures data regarding the structure. This data can be transmitted to a destination where it can be recorded and/or analyzed by the technician or given user. A given destination(s) may be local such as at the structure or proximal to the structure, or may be remote from the structure such as short to long distance communication. A controller/processor (e.g., computer program product) is configured having a number of crack or flaw detection algorithms for assessing the status of such cracks or flaws on the structure.

### CROSS-REFERENCES TO RELATED APPLICATIONS

The present application claims benefit of priority under 35 U.S.C. Section 119(e) from U.S. Provisional Application Ser. No. 60/589,113, filed Jul. 19, 2004, entitled “Integrated Inspection and Light Services System and Method for High Mast Light Poles,” the disclosure of which is hereby incorporated by reference herein in its entirety.

### BACKGROUND OF THE INVENTION

The state of the art in inspecting the structural integrity of high mast towers is to do so visually through un-enhanced eyesight, through binoculars, or by telescope, from a ground location or a hoisted bucket. These methods of inspection are expensive, dangerous, and ineffective.

High mast towers are tall, reaching heights of several hundred feet, thus creating a problem of manually inspecting an upper portion of a tower. Practitioners required to inspect a tower are either required to view the tower from a ground location, a method that does not allow a significantly close inspection of the tower for flaws, or they are required to be raised in a bucket to a higher level to perform a similar analysis, which can be very dangerous.

These conventional methods do not enable a close inspection of the tower given the distance that the practitioner will be from the tower. Thus, a practitioner inspecting a high mast tower will be forced to use a device such as a telephoto lens, binoculars, or a telescope to enable a more meticulous inspection. However, given the upward angles that a practitioner on the ground or in a bucket will face in viewing the tower, the inspection of the tower will never be as adequate as that provided by a level inspection of the structure.

Other conventional methods of inspection involve robotic devices capable of independently climbing a high mast tower. Such inspection methods, while providing closer and more level views of the structure, are problematic in several respects. Existing inspection robots only enable inspection of one view of the tower. Thus, several trips up and down the structure will be necessary for a full inspection.

Magnetic elements enable these robots to move up and down the structure. Thus, a problem arises when the high mast structure is constructed out of a non-magnetic material and the robot is not capable of climbing the tower. Magnetic adhesion to the tower also limits the weight capacity of the robots as they can not carry all of the desired equipment up the tower. Such robots beyond containing an already expensive inspection system must also provide motion and climbing capabilities thus adding a great deal of further expense to the system.

A need arises to provide for inspection of high mast towers and other structures that is effective and provides for a level of inspection of a substantial portion of even the tallest high mast towers and other structures, while at the same time avoid being time intensive, prohibitively expensive, or inherently dangerous to practitioners utilizing it.

### BRIEF SUMMARY OF THE INVENTION

According to an embodiment of the present invention system and method, the inspecting system has an interface member disposed on a platform moveably mounted on or in relation to a generally upright standing structure or underground/subsurface structure, for example. The inspecting system may also have a detector device/means or similar device mounted on the interface member or proximally thereto.

In an embodiment, the inspection system can be used in conjunction with the movably mounted platform to perform inspections of generally upright standing structures or underground/subsurface structure. In order to perform these inspections, a technician or user can mount the interface member and the detector on the platform and/or interface member. The platform can be moved along the length of the structure while the inspector/detector module captures data regarding the structure. This data can be transmitted to a destination where it can be recorded and/or analyzed by the technician or given user. A given destination(s) may be local such as at the structure or proximal to the structure, or may be remote from the structure such as short to long distance communication. A controller/processor (e.g., computer program product) is configured having a number of crack or flaw detection algorithms for assessing the status of such cracks or flaws on a structure.

Various embodiments of the present invention system and method may provide, but not limited thereto, the ability to accomplish the inspection of high mast poles, such as light poles or the like. For example, in an embodiment, it is envisioned that the same highway personnel who conduct the routine light and electrical maintenance work on the high mast light poles will also collect and store the inspection data via the present invention system and method, although this consolidation of functions is not a requirement. For example, a subcontractor to a highway department may elect to utilize the present invention system and method disclosed herein for the inspection function. In an embodiment of the invention, the inspection system includes an interface member (e.g., a universal and quick connect/disconnect adaptor), which can be temporarily mounted on the platform (e.g., lowering ring), and the interface member is able to carry one or more detectors, such as a digital camera, charge coupler device (CCD). Further, the interface member may carry the following: global positioning systems (GPS), robots, lasers, any other desired/required equipment/tool/instrument/system or other sensors such as ultrasound or magnetic eddy currents, or a separate robot, which can be utilized to communicate with or position the inspection detectors/sensors or other desired equipment/tools/instruments/systems. The interface member (e.g., adapter) may be termed “universal” because it shall allow the interface member to be mounted on the varying diameter ranges of the platforms (e.g., lowering rings). In addition, the present invention system may include a power supply mounted on the interface member, and a controller (e.g., a ground-based computer/processor or an interface member-based computer/processor or other desired location-based computer/processor), which communicates and controls the camera system on the universal interface member. The computer may have a Graphical User Interface (GUI) so the highway personnel or designated user can utilize the system without a significant amount of training. The communications may be, for example, wireless communications based on standard IEEE protocols, other radio frequency and optical communication standard, or any other available modes (hardware and software) of communication. In addition, the computer system of the controller may have a number of software products for such functions as crack or flaw detection (surface and/or subsurface); internet based transfer of files, and other desired or required functions or applications. Accordingly, an embodiment of the present invention eliminates the need for specifically scheduling pole inspection by combining pole inspection function with the pole maintenance function, and thus provides a cost reduction opportunity. It should be appreciated that various embodiments of the present invention system and method may be utilized with a wide variety of erected structures requiring inspection or the like.

An aspect of an embodiment of the present invention system is directed to a system for use with a platform movable in relation to a generally upright standing structure for inspecting the structure. The system comprising: an interface member disposed on the platform; and at least one detector device disposed on the interface. A computer processor is in communication with the system and detector device for receiving data there from. In an embodiment the computer processor is adapted to provide inspection results according to the data received of the detector device and the system. The inspection results provides crack or flaw information regarding the structure.

An aspect of an embodiment of the present invention method is directed to a method for use with a platform movable in relation to a generally upright standing structure, for inspecting the structure. The method comprising: disposing an interface member on the platform; disposing a detector device on the interface member to provide data; and processing the data received from the detector device and the system to calculate inspection results of the structure. In an embodiment the method the inspection results provides crack or flaw information regarding the structure.

An aspect of an embodiment of the present invention method for manufacturing an inspection system, is for use with a platform movable in relation to a generally upright standing structure, for inspecting the structure. The method comprising: disposing an interface member on the platform; and disposing a detector device on the interface member. The method may further comprise providing a processor in communication with the system.

An aspect of an embodiment of the present invention method for manufacturing an inspection system for inspecting a generally upright standing structure. The method comprising: mounting a platform on the structure, wherein the platform being movably mounted in relation to the structure; disposing an interface member on the platform; and disposing a detector device on the interface member. The method may further comprise providing a processor in communication with the system.

An aspect of an embodiment of the present invention provides a computer program product comprising a computer useable medium having computer program logic for enabling at last one processor in communication with an inspection system of a structure to provide inspection results according to data received from the system. The computer program logic comprising: a) receiving data that represents actual width of a base portion of the structure; b) receiving data that represents the distance between the base portion of the structure to a subject crack or flaw located in the structure; c) receiving the actual width of the structure at location of the subject crack or flaw; d) receiving location points inputted that represent crack or flaw points and receiving width points inputted that represent width points; and e) calculating the actual dimensions of the subject crack or flaw based on the relationship between the inputted crack or flaw points and inputted width points as provided in step ‘d’ with the actual pole width of the subject crack or flaw as provided in step ‘c”. The inspection results provides crack or flaw information regarding the structure.

These and other objects, along with advantages and features of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 is a schematic perspective view of an exemplary embodiment of an aspect of the inspection system.

FIG. 2 is a perspective view of an exemplary embodiment of the interface member.

FIG. 3 is a perspective view of an exemplary embodiment of the interface member.

FIG. 4 is a perspective view of an exemplary embodiment of a joint of the interface member.

FIG. 5 is an operative view of an exemplary embodiment of the interface member in relation to the platform near the base of the structure for the inspection system.

FIG. 6 is an operative view of an exemplary embodiment of the interface member in relation to the platform near the apex of the structure for the inspection system.

FIG. 7 is a schematic block diagram of an exemplary embodiment of the communication aspect of the inspection system.

FIG. 8 is an operative view of an exemplary embodiment of the graphical user interface/computer interface of the inspection system.

FIG. 9 is a schematic plan view of an exemplary embodiment of an aspect of the inspection system.

FIG. 10(A) is an operative view of an exemplary embodiment of the graphical user interface/computer interface of the inspection system. FIG. 10(B) is an enlarged partial view of the interface shown in FIG. 10(A).

### DETAILED DESCRIPTION OF THE INVENTION

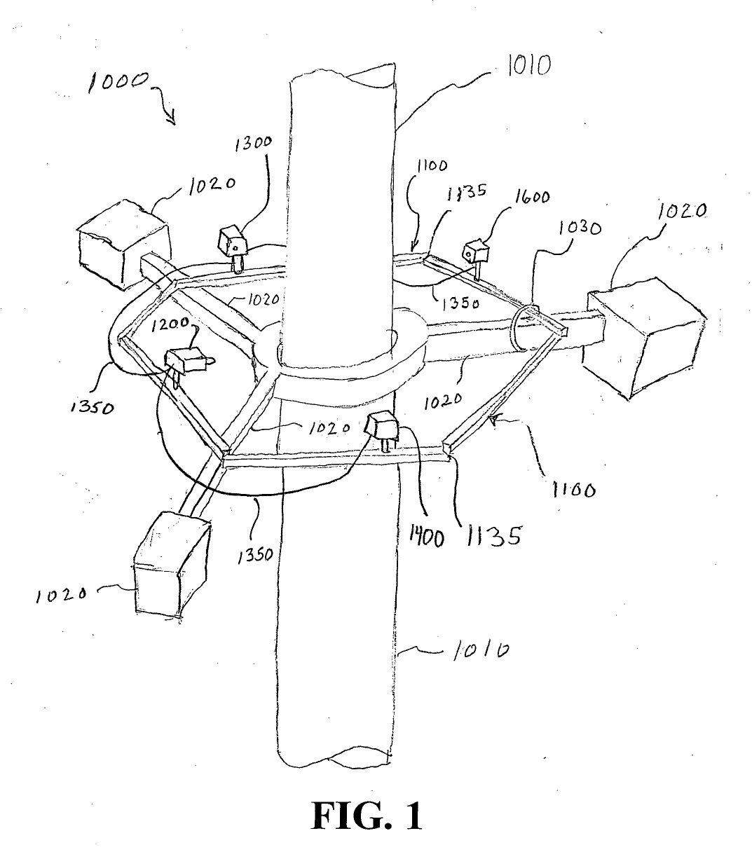

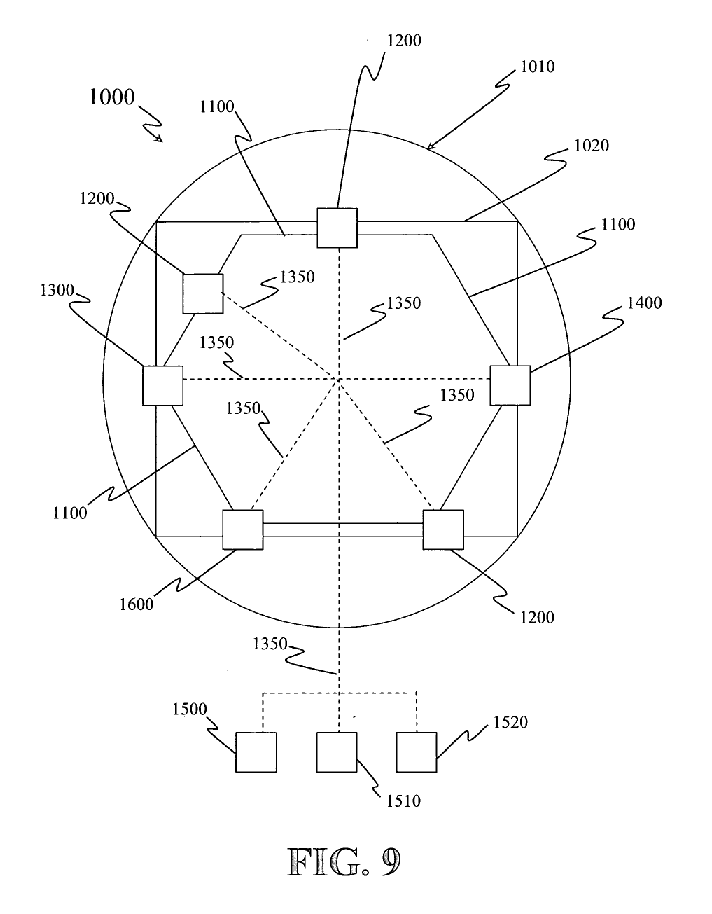

Turning to FIG. 1, FIG. 1 provides a schematic perspective view of an exemplary embodiment of an inspection system 1000 that can be used for inspecting, viewing and/or scanning, etc. a structure 1010, such a mast pole, subsurface structure or equipment or the like. The interface member 1100 can at least partially enclose, encircle and/or surround the structure 1010. Moreover, the interface member 1100 may be located at least partially inside of or on an interior position of a structure, as schematically illustrated in FIG. 9. Further, the interface member 1100 may be located at any variety of locations with respect to the structure, such as, but not limited thereto, above or below. The Structure 1010 can be a high mast lighting tower (e.g., roadway, shipping ports, parking lot, and athletic stadiums/facilities), cell tower, and/or an antenna tower, cranes, various piping, tubing, girders, bits, elevator shaft infrastructure, off-shore platform, theme park or ball park structure, or any other desired structures or towers. Such structures may be vertically or horizontally aligned or any angle/alignment there between. Additionally, the structure may be for example, elevator cables or electrical cables that require inspection. Moreover, it should be appreciated that the structure may be any erected structure requiring inspection, survey or communication there with. The structure or equipment intended to be inspected may be any above-surface or sub-surface structure or equipment. In an embodiment, the interface member 1100 may be any variety of type of bands or rings. Moreover, the interface member 1100 may have any variety of shapes, sizes dimensions and attributes so as to accommodate a given platform 1020 and/or structure 1010 requiring inspection or monitoring. The band or ring may be a wide variety of circumferential shapes or semi-circumferential shapes such as, such as but not limited to, polygon, hexagon, rectangle, and/or an octagon, etc. Similarly, the band may be a circle, oval, bow, curve, and/or an arc, etc. The interface member 1100 may be individual components intermittently (i.e., non-continuous) mounted on a platform 1020, such as a lowering ring. The platform 1020 can be a lighting rack, maintenance rack, robot, cleaning/monitoring device, an observation deck, top or bottom of elevator (or other specified location), or any structure or equipment that may be found on or with an erected structure or equipment (above or below a surface).

Components of the inspection system 1000 can be at least partially supported by or disposed on the structure 1010, interface member 1100 and/or platform 1020, as well as any proximal or remote location from the structure under inspection or monitoring. Components of the inspecting system 1000 can be removably mounted on the platform 1020, structure 1010, or interface member 1100, as well as any proximal or remote location from the structure under inspection or monitoring. The interface member 1100 can be coupled to the platform 1020 by a variety of attachment devices or means 1030, for example a tether. The attachment or coupling device 1030 may be a tie rope, cord, hinge, lock, pivot, coupling, key, latch, lug, nail, dowel, nut and bolt, screw, latch, lock, joint and/or a clamp, etc. It should be appreciated that various components of the inspection system or a portion thereof can be permanently or removably affixed to the platform and/or structure.

The inspecting system 1000 further comprises a detector device 1200. The detector device 1200 can comprise a video camera, a digital video camera, thermal imaging camera, radio frequency detector, a still-life camera, ultrasound device, eddy current device, magnetic particle inspection (MPI), magnetic resonance imaging (MRI) device, any data acquisition device, etc. The detector device (as well as the auxiliary device or external device) can itself comprise a robotic system for additional reach on the structure 1010. The detector device 1200 is adapted to transmit and/or receive data. Such transmission may be wireless or hard wired, such as but not limited thereto being implemented using wire, cable, fiber optics, phone line, cellular phone link, RF link, blue tooth, infrared link, integrated circuits, and other communications channels. The detector device or means 1200 may have pan and/or zoom capabilities. The detector device 1200 may have recording and memory storage capabilities, as well as data processing capabilities. The detector device 1200 may be mounted on the interface member 1100 and/or on platform 1020. It should be appreciated that the detectors devices may be used for monitoring, inspecting and/or positioning. Similarly, other devices or instruments may be substituted or added to accomplish the same function(s).

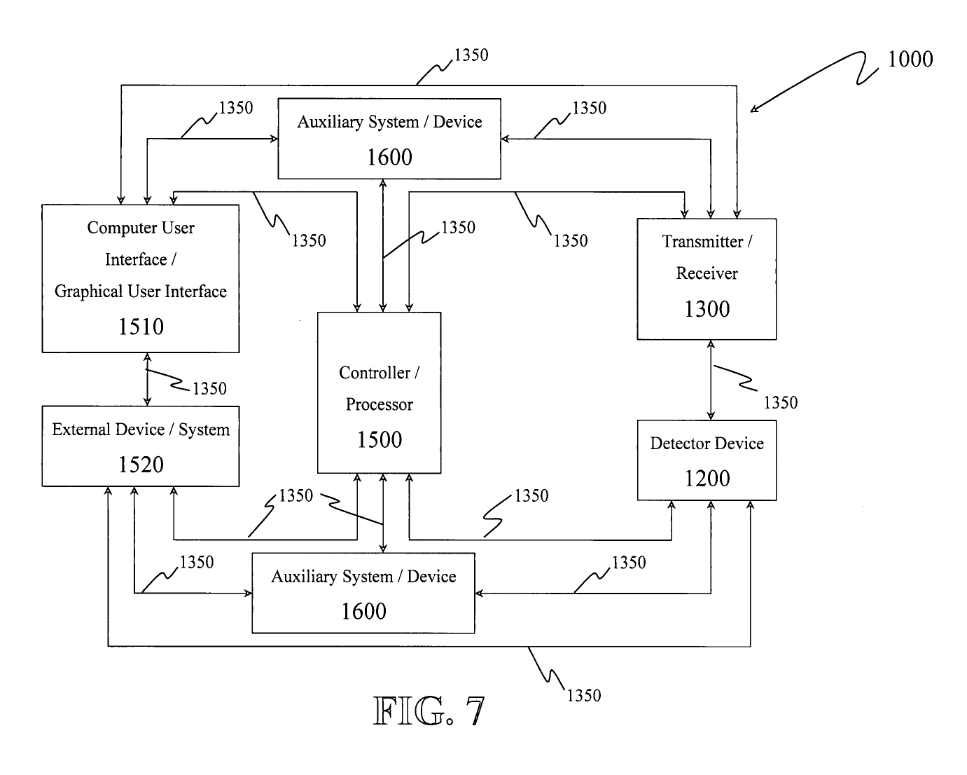

The inspection system 1000 further comprises a transmitter and/or receiver 1300. The transmitter/receiver (or transceiver) 1300 may be operatively coupled to the detector device 1200. It should be appreciated that the transmitter device, receiver device and detector can be separate or integral units. Moreover, there may be a plurality of transmitter and receiver devices utilized in the inspection system 1000 so as to allow any of the modules/devices/instruments/processors to communicate with one another. The transmitter and/or receiver 1300 can be operatively coupled to a controller (as shown in FIG. 7). The transmitter and/or receiver 1300 may comprise a wireless transmitter/receiver and is adapted to receive and transmit data. Accordingly, the transmitter and/or receiver 1300 may be adapted to transmit via a physical connection or wireless connection, such as, but not limited to, cable, wire, optical fiber, phone line, cellular phone link, integrated circuit, RF link, Blue Tooth, infrared link and other communications channels, etc. The transmitter and/or receiver 1300 may be removably and/or permanently affixed to the platform 1020, structure 1010 and/or an interface member 1100. It should be appreciated there may be a plurality of transmitters and/or receivers 1300 in communication with any of the various components or modules of the inspection system 1000 that are mentioned herein. The transmitters and/or receivers may be integral or separate with one another. Moreover, the transmitter and/or receivers may be integral or separate with any of the various components or modules of the inspection system 1000 that are mentioned herein.

The inspecting system I 000 may comprise a power supply 1400 as shown in FIG. 1. The power supply 1400 can be operatively coupled to the detector device 1200 and/or transmitter and/or receiver 1300. It should be appreciated that the power supply 1400 and detector device 1200 (or any other equipment, tool, instrument, system mentioned herein) may be separate or integral units. Similarly, it should be appreciated that the power supply 1400 and transmitter and/or receiver 1300 (or any other equipment, tool, instrument, system mentioned herein) may be separate or integral units. Further, it should be appreciated that the power supply 1400, transmitter and/or receiver 1300 and detector device 1200 (or any other equipment, tool, instrument, system mentioned herein) may be integral units. The power supply 1400 can be an independent power supply, such as, but not limited to, a generator, battery and/or solar array, etc. The power supply 1400 may be a dependent power supply. It should be appreciated that the power supply may be located on any component of the inspection system or may be proximally located such as at the base of the structure or remotely from the structure (or area under inspection). The transmission of power to the system may be of any available means.

Further, the inspection system 1000 may also comprise or be in communication with an auxiliary system/device/instrument 1600, as well as a plurality of such systems/devices/instruments. Such auxiliary system/device/instrument 1600 may include, but not limited thereto, the following: communication devices/systems, robots, global positioning systems, positioning devices/systems, monitoring device/system or laser device or any other device/system/instrument as desired or required.

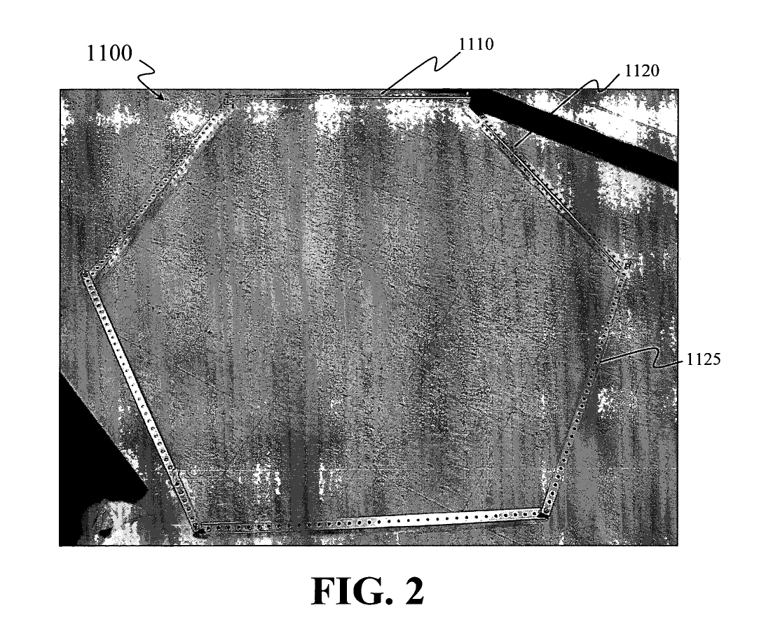

FIG. 2 is a perspective view of an exemplary embodiment of the interface member 1100. The interface member 1100 may be of a one-piece and/or multi-piece design. The interface member 1110 may comprise a first segment 1110 and/or a second segment 1120. The second segment 1120 can be releasably coupled to the first segment 1110. The first segment 1110 and/or second segment 1120 may be detachable from the interface member 1100. The interface member 1100 may comprise a third segment 1125. It should be appreciated that interface member 1100 may comprise more than three segments. The interface member may be formed to provide a complete perimeter around the structure or rather only intermittent or staggered portions around, inside or adjacent to the structure or equipment being inspected or monitored. The segment members may be, but not limited thereto, the following: plates, posts, arms, branches, fingers, frames, legs, rods, sleeves, struts, tracks, trusses, shoulders, or studs, as well as any combination thereof.

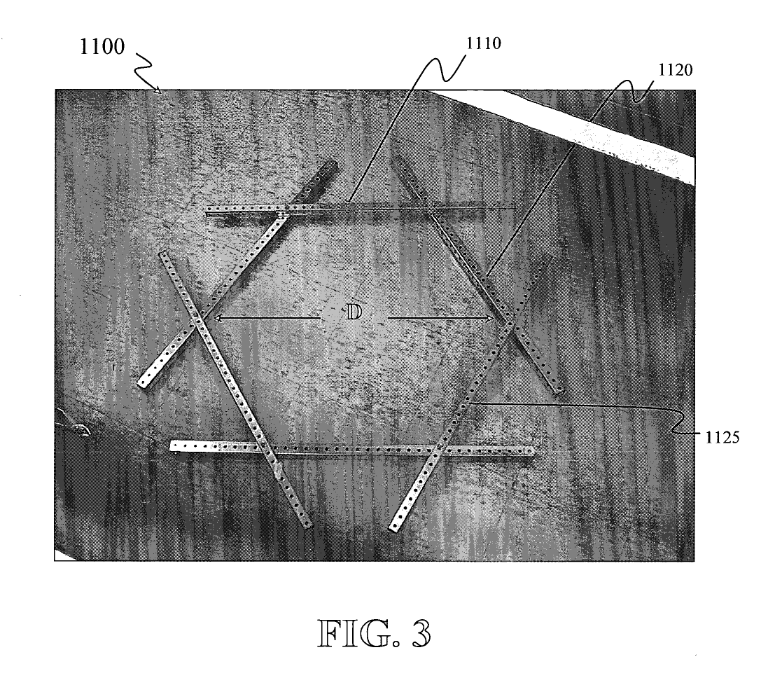

FIG. 3 is a perspective view of an exemplary embodiment of the interface member 1100. The interface member 1100 may be shaped substantially in the form of a band or ring having a variety of circumferential shapes or semi-circumferential shapes such as, but not limited thereto, polygon, regular polygon, rectangular, hexagon, octagon, circular, oval or are-shaped, etc. The interface member 1100 may have an adjustable diameter as referenced as D, for example. The diameter, D, of the band may be any variety of sizes or dimension so as to accommodate, the structure or equipment, interface member, platform and/or various components/modules/instruments of the inspection system. The interface member 1100 can be constructed of a variety of materials such as, but not limited to metals, steels, alloys, wood, composites, polymers, plastics or any combination thereof. The material may be any suitable material or composite necessary to accomplish the desired function. The interface member may be a variety of rigid structures such as perforated steel as shown. By way of example only, poles constructed of non-magnetic materials, a robotic device or given component may use suction cups or similar means to stick to the pole.

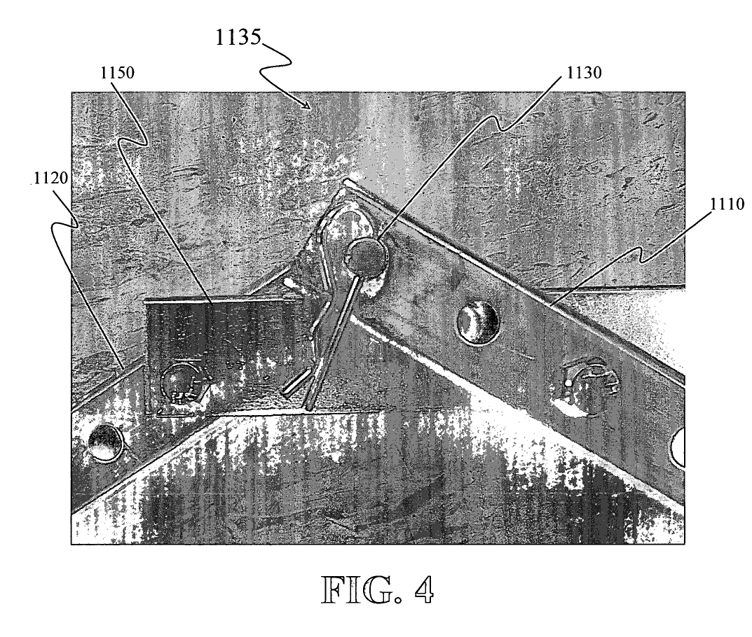

Turning to FIG. 4, FIG. 4 is a perspective view of an exemplary embodiment of a joint 1135 of the interface member 1100. The joint 1135 may be a variety of coupling means including, but not limited thereto, rope, cord, hinge, pivot, coupling, key, latch, lug, nail, dowel, nut and bolt, screw, latch, lock, joint and/or a clamp, etc. The Interface member 1100 may have removable support plates 1150, such as posts, arms, branches, fingers, frames, legs, rods, sleeves, struts, tracks, trusses, shoulders, or studs. The support plates can fix an angle in the interface members 1100 to approximately a predetermined degree between the segment 1110 and 1120, for example. The segment 1120 can be releasably coupled to another segment 1110 via the coupling mechanism 1130 and/or support plate 1150. The coupling mechanism 1130 can be a clamp, rope, lock, pivot, latch, lug, dowel, nut and bolt, screw, bolt, key, pin, cotter pin, tie, or any suitable attachment or binding means. It should be appreciated that interface member may be coupled with the joints 1135 without the use of support plates 1150.

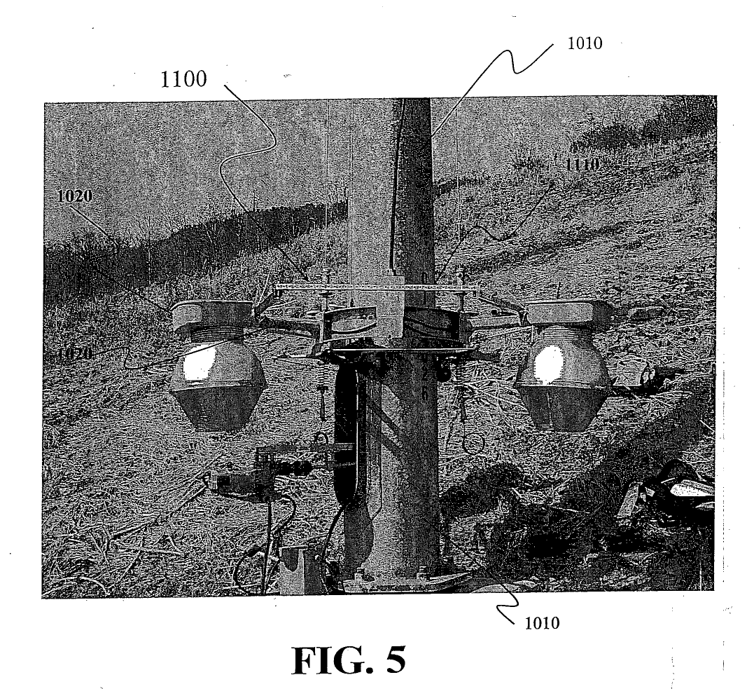

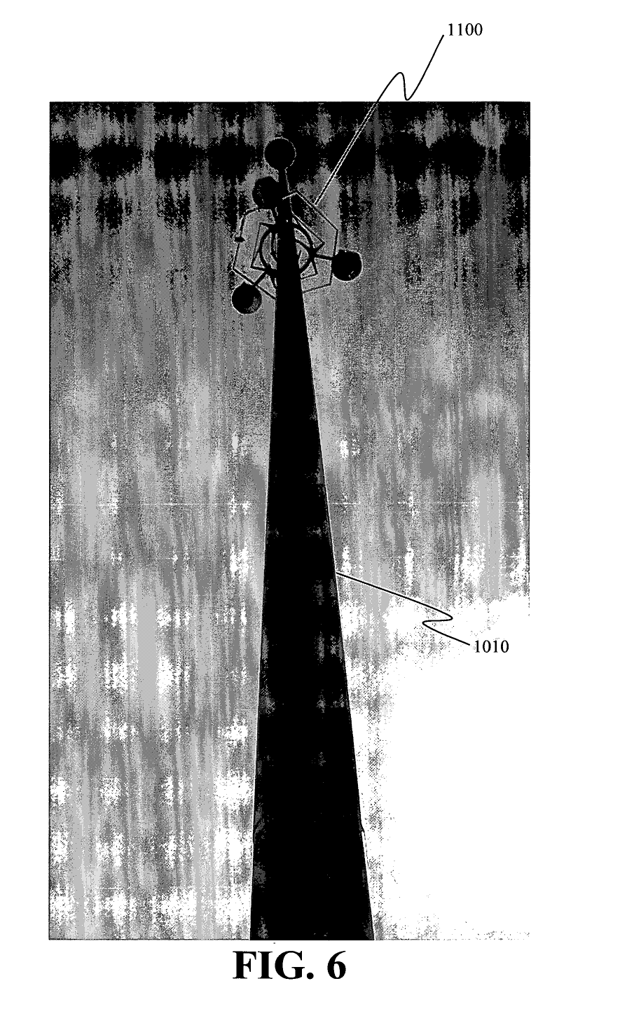

Next, turning to FIG. 5, FIG. 5 illustrates an operative view of an exemplary embodiment of the interface member in relation to the platform near the base of the structure. The platform 1020 can be lowered to a position at and/or near the base of the structure 1010. The various components or modules of the inspection system 1000 can be disposed on the platform 1020 and/or structure 1010 while the platform is in a lowered state. As the platform 1020 is raised, and/or at intermittent stopping points on its path of elevation, the inspecting system captures data regarding the structure 1010. The inspection system can perform the inspection up to the apex of the platform path or any point between the base and the apex (as shown in FIG. 6). The platform can be lowered and the inspection components can be removed or attended to as desired or required.

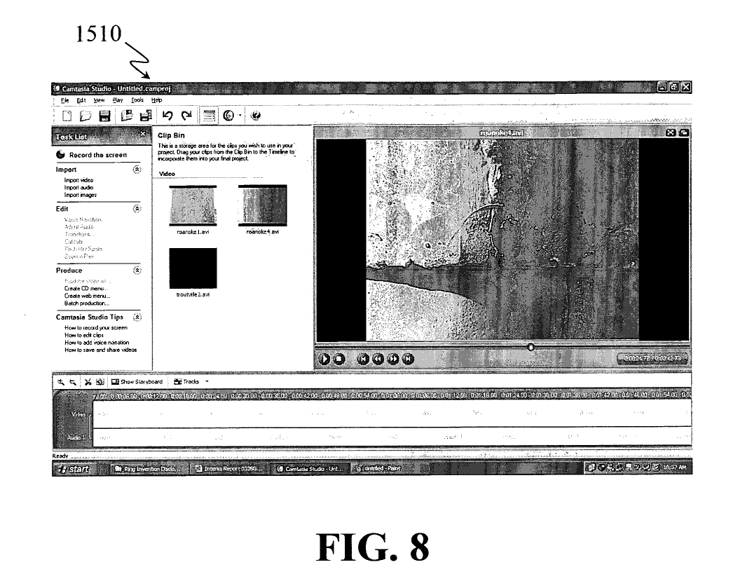

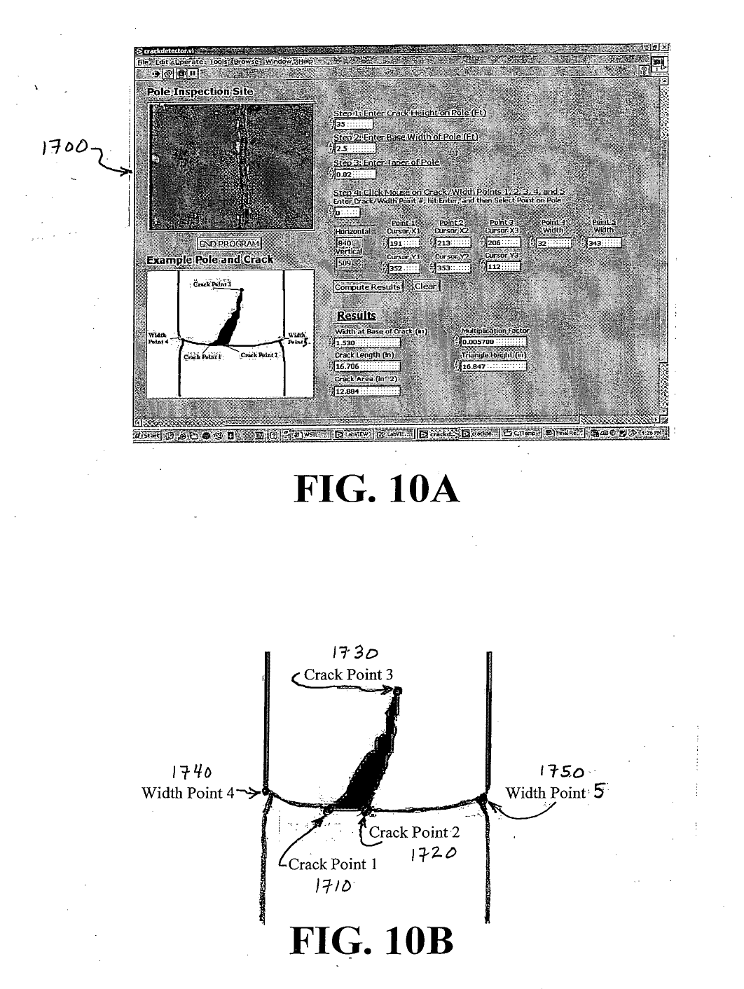

Turning to FIG. 7, FIG. 7 illustrates a schematic block diagram of an exemplary embodiment of the communication aspect of the inspection system 1000. The data can be captured by the detector device 1200 (or any other equipment, tool, instrument, system, module, mentioned herein), wherein the data can be transferred between the transmitter and/or receiver 1300 from the detector device 1200 (or any other equipment, tool, instrument, system, module mentioned herein). The data can be transmitted by the transmitter and/or receive 1300 to a controller/processor 1500. The controller/processor 1500 may comprise a mobile or stationary computing or processing device, television, oscilloscope and/or various measuring or interactive devices/instruments/equipment, etc. A technician or user can analyze (or process as deemed appropriate) this data as it is received by the controller/processor and/or record the data for future analysis or as desired. The technician or user can use a graphical user interface/computer user interface 1510 (as shown FIG. 8 and FIG. 10) to send/receive control signals or data from the controller/processor device to the transmitter and/or receiver 1300, detector device 1200(or any other equipment, tool, instrument, system mentioned herein) and/or auxiliary system/device/instrument 1600. Examples of the controller/processor may be a variety of processors implemented using hardware, software or a combination thereof and may be implemented in one or more computer systems or other processing systems, such as general purpose computer or personal digital assistants (PDAs).

It should be appreciated that the communication of data and information transferred among the modules and components of the inspecting system may be implemented using software and data transferred via communications interfaces that are in the form of signals, which may be electronic, electromagnetic, optical, RF, infrared or other signals capable of being received by communications interfaces. The signals may be provided via communications paths or channels 1350 (or any other communication means or channel disclosed herein or commercially available) that carries signals and may be implemented using wire or cable, fiber optics, integrated circuitry, a phone line, a cellular phone link, an RF link, an infrared link and other communications channels/means commercially available.

Other examples of the computer user interface/graphic user interface 1510 may include various devices such as, but not limited thereto, input devices, mouse devices, keyboards, monitors, printers or other computers and processors. The computer/graphic user interface may be local or remote. It should be appreciated that there may be one or more computer user interface/graphic user interface 1510 that may be in communication with any of the components, modules, instruments, devices, systems and equipment discussed herein. For example, the computer user interface/graphic user interface 1510 may be remotely located. Such a remote communication of the computer user interface/graphic user interface 1510 may be accomplished a number of way including an uplink/communication path 1350 to a cell telephone network (e.g., external device/system 1520) or satellite (e.g., external device/system 1520) to exchange data with a central processing point (e.g., external device/system 1520).

The inspection system may also be in communication with an external device(s) or system(s) 1520 such as at least one of the following transmitters, receivers, controllers/processors, computers, satellites, telephone cell network, PDA's, workstations, and other devices/systems/instruments/equipment. The aforementioned external device/systems 1520 may be comprised of one or plurality and may be locally and/or remotely located.

Further, the inspection system 1000 may also comprise or be in communication with an auxiliary system/device/instrument 1600, as well as a plurality of such systems/devices/instruments. Such auxiliary system/device/instrument 1600 may include, but not limited thereto, the following: communication device/system, robot, global positioning system (GPS), laser devices, positioning device/system, monitoring device/system, laser device or any other device/system/instrument as desired or required. The aforementioned auxiliary device/system/instrument 1520 may be comprise of one or plurality and may be locally and/or remotely located.

FIG. 8 shows an exemplary embodiment of a computer/graphic user interface 1510. The user interface 1510 can comprise a graphical user interface as shown. The user interface 1510 can display data received and/or transmitted. The control signals sent from or to the user interface 1510 can alter the functionality of the detector, such as, but not limited to, positioning, monitoring, inspecting, panning and/or zooming, and or focusing, etc. The control signals sent from or to the user interface 1510 can also alter the functionality of the any component or module of the inspection system mentioned herein including, for example, the external device, auxiliary device, and controller/processor)

Turning to FIG. 9, FIG. 9 provides a schematic plan view of an exemplary embodiment of an inspection system 1000 that can be used for inspecting, viewing, positioning and/or scanning, etc. a structure 1010. The interface member 1100 is located at least partially inside of or on the interior position of a structure or equipment 1010, as schematically illustrated in FIG. 9. The structure 1010 may be a variety of structures or equipment such as, but not limited thereto, towers, piping, tubing, girders, shafts, elevator shafts, etc. Additionally, the inspection system 1000 structure may be adjacent or proximal to the structure or equipment being inspected, monitored, analyzed or positioned. Any one or all of the components/modules as illustrated and discussed throughout—detector device 1200, transmitter and/or receiver 1300, power supply 1400, controller/processor 1500, user interface 1510, external device 1520, and auxiliary systems/devices/instruments 1600-may be in communication via the communication path/channel 1350. It should be appreciated that anyone of the aforementioned components/modules may be singular or plural as well as separate or integral with other respective components/modules.

FIG. 10(A) shows an exemplary embodiment of a computer/graphic user interface 1700. The user interface 1710 can comprise a graphical user interface as shown. The user interface 1700 can display data received and/or transmitted. FIG. 10(B) is an exploded partial view of the interface shown in FIG. 10(A).

The computer processor(s) 1500 as discussed throughout may be comprised of hardware, software or any combination thereof to process the data to determine the outcome or interested result of an inspection on a high mast pole or given structure or equipment. It should be appreciated that the controller/processor 1500 may be adapted with a variety of software and/or hardware having a number crack or flaw detection (surface and/or subsurface) algorithm or process capabilities. In an embodiment, the processor may include the following algorithm for purpose of inspecting a crack or flaw on a structure (e.g., pole): receive the actual width of the base of the structure (e.g., pole); receive the distance between the base of the structure (e.g., pole) to the crack or flaw, receive the actual width of the structure (e.g., pole) at the crack or flaw; receive the crack points or flaw points (as referenced as 1710, 1720, and 1730) and width points (as referenced as 1740 and 1750) data according to the locations illustrated in FIG. 10(B) so as to provide “screen image data”; and calculate the actual dimensions of the crack or flaw based on the relationship between the “screen image data” pole width with the actual pole with at the crack or flaw. A benefit of this method is that all crack or flaw measurements can be performed either in the field or at remote location (e.g., home office or satellite location) after the field data have been collected.

In an embodiment, the following method may be implemented:

1. utilize a measuring device, such as tape, laser, or any type of distance determining device to measure the actual width of the base of the pole;

2. utilize an ultrasonic distance measurement device or manual measurement (or other automated device) to measure the distance from the base of the pole to the crack or flaw;

3. calculate (e.g., via software) the actual width of the pole at the crack or flaw, which may be accomplished from knowledge of the pole taper or other information;

4. calculate (e.g., via software) the screen image dimensions of the crack or flaw, as shown in FIG. 10(B) as references 1700, 1720 and 1730 (for example), and entered accordingly, as compared to the screen image width of the pole, as shown in FIG. 10(B) as references 1740 and 1750 (for example), and entered accordingly; and

5. calculate (e.g., via software) the actual dimensions of the crack or flaw based on the relationship between screen image pole width (e.g., FIG. 10(B))and actual pole width at the crack or flaw.

Using only two measured pieces of data, and the manufacturer supplied pole taper specifications, the software (e.g., prototype LABVIEWS-based software program or other available programming languages) produces crack or flaw dimensions (height and width). A benefit of this method, but not limited thereto, is that all crack measurements can be performed either in the field or at the home office after field data have been collected.

In this document, the terms “computer program medium” and “computer usable medium” are used to generally refer to media such as removable storage drive, a hard disk installed in hard disk drive, and signals. These computer program products are means for providing software to computer system. The various embodiments of invention includes such computer program products. Computer programs (also called computer control logic) are stored in main memory and/or secondary memory. Computer programs may also be received via communications interface and/or communication path/channel. Such computer programs, when executed, enable computer system to perform the features of the present invention as discussed herein. In particular, the computer programs, when executed, enable processor to perform the functions of various embodiments of the present invention. Accordingly, such computer programs may represent controllers of a computer system. In an embodiment where the invention is implemented using software, the software may be stored in a computer program product and loaded into computer system using removable storage drive, hard drive or communications interface. The control logic (software), when executed by the processor, causes the processor to perform the functions of the invention as described herein. In another embodiment, the invention is implemented primarily in hardware using, for example, hardware components such as application specific integrated circuits (ASICs). Implementation of the hardware state machine to perform the functions described herein will be apparent to persons skilled in the relevant art(s). In yet another embodiment, the invention is implemented using a combination of both hardware and software. The methods described above could be implemented in a variety of available program languages.

The various embodiments of the present invention system and method may be implemented with the following systems and methods disclosed in the following U.S. patents, U.S. Patent Application Publications, European Patents and European Publications and of which are hereby incorporated by reference herein in their entirety:

U.S. Pat. No. 6,816,085 B1 to Haynes et al., entitled “Method for Managing a Parking Lot;”

U.S. Pat. No. 6,697,710 B2 to Wilcox, entitled “Gas Pipe Explorer Robot;”

U.S. Pat. No. 6,484,981 B1 to Perrault, entitled “Removable Load Support System;”

U.S. Pat. No. 5,954,305 to Calabro, entitled “Adaptable Antenna Mounting Platform for Fixed Securement to an Elongated Mast Pole;”

U.S. Pat. No. 5,392,359 to Futamura et al., entitled “Apparatus for Inspecting Appearance of Cylindrical Objects;”

U.S. Pat. No. 5,847,753 to Gabello et al., entitled “Camera System for Scanning a Moving Surface;”

U.S. Pat. No. 4,708,307 to Daigle, entitled “Stand for Holding Leaf Bags;”

U.S. Pat. No. 4,228,399 to Rizzo et al., entitled “Offshore Pipeline Electrical Survey Method and Apparatus;”

U.S. Pat. No. 4,139,884 to Thompson, entitled “Luminaire Lowering Device;”

U.S. Pat. No. 4,092,707 to Millerbernd, entitled “High Level Light Supporting and Light Lowering Means;”

U.S. Pat. No. 4,051,525 to Kelly, entitled “Raisable and Lowerable Surveillance Camera Assembly;”

U.S. Pat. No. 3,805,054 to Wolf, entitled “Ground Level Service Rack for Pole-Mounted Fixtures;”

U.S. Pat. No. 3,670,159 to Millerbernd, entitled “High Level Light Pale Including Means for Lowering Lights for Servicing;”

PCT International Application Publication No. WO 2004/095386 A1 to Murphy, entitled “Surveillance Apparatus, System and Method;”and

European Patent Application Publication EP 1 262 771 A2 to Wayman et al., entitled “Pipe Condition Detecting Apparatus.”

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A system for use with a platform movable in relation to a generally upright standing structure for inspecting the structure, comprising:
an interface member disposed on the platform; and
at least one detector device disposed on said interface.

2. The system of claim 1, further comprising:
a computer processor, said computer processor in communication with said system and detector device for receiving data there from.

3. The system of claim 2, further comprising:
an external device, said computer processor in communication with said external device.

4. The system of claim 2, further comprising:
a computer interface for receiving data received from said computer processor.

5. The system of claim 2, further comprising:
a transmitter and receiver device, said transmitter and receive device adapted to exchange said data between said detector device and said computer processor.

6. The system of claim 5, wherein said transmitter and receiver device is a wireless or hard-wired or combination of both.

7. The system of claim 2, further comprising:
at least one communication channel among said detector device and said computer process.

8. The system of claim 7, wherein said at least one communication channel comprises at least one of the following: hard wire communication or wireless communication.

9. The system of claim 7, wherein said at least one communication channel comprises at least one of the following: fiber optics, phone line, cellular phone link, RF link, blue tooth, and infrared link and other communications channels.

10. The system of claim 2, wherein said computer processor being adapted to provide inspection results according to the data received of said detector device and said system.

11. The system of claim 10, wherein the inspection results provides crack or flaw information regarding the structure.

12. The system of claim 11, said crack or flaw information regarding the structure is determined by a process comprising:
a) receive data that represents actual width of a base portion of the structure;
b) receive data that represents the distance between the base portion of the structure to a subject crack or flaw located in the structure;
c) receive the actual width of the structure at location of the subject crack or flaw;
d) receive location points inputted that represent crack or flaw points and receive width points inputted that represent width points; and
e) calculate the actual dimensions of the subject crack or flaw based on the relationship between the inputted crack or flaw points and inputted width points as provided in step ‘d’ with the actual pole width of the subject crack or flaw as provided in step ‘c”.

13. The system of claim 12, wherein said process further includes determining whether structure should be replaced.

14. The system of claim 12, wherein said process further includes determining whether structure should be repaired.

15. The system of claim 1, wherein said detector is adapted to perform at least one of the following: detecting, inspecting, monitoring, positioning or marking.

16. The system of claim 1, further comprising:
a computer interface for receiving data received from said detector device.

17. The system of claim 16, further comprising:
an external device, said computer interface adapted to exchange data between said computer interface and said external device.

18. The system of claim 16, further comprising:
a transmitter and receiver device, said transmitter and receive device adapted to exchange said data between said detector device and said computer interface.

19. The system of claim 18, further comprising:
an external device, said transmitter adapted to exchange data between said transmitter and receiver device and said external device.

20. The system of claim 18, wherein said transmitter and receiver device is a wireless or hard-wired or combination of both.

21. The system of claim 18, wherein said computer interface comprises at least one of processor, graphical user interface (GUI), input means, monitor screen, personal digital assistant (PDA), printer device, oscilloscope, or television.

22. The system of claim 1, wherein said interface member partially circumferentially surrounds the standing structure.

23. The system of claim 1, wherein said interface member is at least partially disposed inside of the standing structure.

24. The system of claim 1, wherein said interface member is at least partially disposed adjacent to the standing structure.

25. The system of claim 1, wherein said interface member comprises a partial band member.

26. The system of claim 25, wherein said partial band segment forms an arc shape.

27. The system of claim 1, wherein said interface member circumferentially surrounds the standing structure.

28. The system of claim 1, wherein said interface member comprises a band member.

29. The system of claim 28, wherein said band member is adapted to have an adjustable diameter.

30. The system of claim 28, wherein said band member includes a shape comprised of at least one of: polygon, hexagon, rectangular, octagon, oval or circular.

31. The system of claim 1, wherein said interface member comprises a plurality of segment members.

32. The system of claim 31, wherein said segment members are detachable from one another.

33. The system of claim 31, wherein said segment members comprise at least one of posts, arms, branches, fingers, frames, legs, rods, sleeves, struts, tracks, trusses, shoulders, or studs, or any combination thereof.

34. The system of claim 31, wherein said segment members are detachable from the platform.

35. The system of claim 31, further comprises:
joints, said joints interconnect said segment members.

36. The system of claim 31, further comprises:
support plates, said support plates are aligned between adjacent said segment members thereby defining angles between adjacent said segment members.

37. The system of claim 36, wherein said support plates are adapted substantially fix said angles in place.

38. The system of claim 36, wherein said support plates comprise at least one of posts, arms, branches, fingers, frames, legs, rods, sleeves, struts, tracks, trusses, shoulders, or studs, or any combination thereof.

39. The system of claim 1, wherein said detector device being oriented substantially facing the standing structure.

40. The system of claim 1, wherein said detector device comprises at least one of the following: thermal imaging, radio frequency detector, camera, image acquisition device, charge coupler device (CCD), magnetic particle inspection (MPD), still camera, digital camera, digital video camera, a still-life camera, magnetic particle inspection (MPI), ultrasound device, magnetic eddy current device, magnetic resonance imagining (MRI) device.

41. The system of claim 1, further comprises:
an auxiliary device in communication there with.

42. The system of claim 41, wherein said auxiliary device comprises at least one of the following:
communication device/system, robot, global positioning system (GPS), positioning system, surveillance system, tagging system, monitoring device/system, or laser device.

43. The system of claim 1, wherein said detector device comprises a data acquisition device.

44. The system of claim 1, wherein the standing structure comprises a high mast structure.

45. The system of claim 1, wherein the high mast structure comprises a lighting structure.

46. The system of claim 1, wherein the standing structure comprises a sub-surface structure.

47. The system of claim 1, wherein the standing structure comprises at least one of the following: roadway structure, shipping port structure, theme park structure, parking lot structure, and athletic stadium/facility structure, cell tower, antenna tower, or crane boom.

48. The system of claim 1, further comprising a power supply.

49. The system of claim 48, wherein said detector device being operatively coupled to said power supply.

50. A method, using a platform movable in relation to a generally upright standing structure, for inspecting the structure, said method comprising:
disposing an interface member on the platform;
disposing a detector device on said interface member to provide data; and
processing said data received from said detector device and said system to calculate inspection results of the structure.

51. The method of claim 50, wherein the inspection results provides crack or flaw information regarding the structure.

52. The method of claim 51, said crack or flaw information regarding the structure is determined a process comprising:
a) receiving data that represents actual width of a base portion of the structure;
b) receiving data that represents the distance between the base portion of the structure to a subject crack or flaw located in the structure;
c) receiving the actual width of the structure at location of the subject crack or flaw;
d) receiving location points inputted that represent crack or flaw points and receiving width points inputted that represent width points; and
e) calculating the actual dimensions of the subject crack or flaw based on the relationship between the inputted crack or flaw points and inputted width points as provided in step ‘d’ with the actual pole width of the subject crack or flaw as provided in step ‘c”.

53. The method of claim 52, wherein said process further includes determining whether structure should be replaced.

54. The method of claim 52, wherein said process further includes determining whether structure should be repaired.

55. The method of claim 50, wherein the inspection of the structure occurs while the platform moves in relation to the structure.

56. The method of claim 50, wherein the inspection of the structure occurs while the platform is stationary in relation to the structure.

57. The method of claim 50, wherein data is transmitted from said detector device for said processing.

58. The method of claim 50, further comprising:
transmitting data from said detector device to an external device.

59. The method of claim 50, further comprising transmitting said processed data to an external device.

60. A method for manufacturing an inspection system, for use with a platform movable in relation to a generally upright standing structure, for inspecting the structure, said method comprising:
disposing an interface member on the platform; and
disposing a detector device on said interface member.

61. The method of claim 60, further comprising providing a processor in communication with said system.

62. A method for manufacturing an inspection system for inspecting a generally upright standing structure, said method comprising:
mounting a platform on the structure, wherein said platform being movably mounted in relation to the structure;
disposing an interface member on the platform; and
disposing a detector device on the interface member.

63. The method of claim 62, further comprising providing a processor in communication with said system.

64. A computer program product comprising a computer useable medium having computer program logic for enabling at last one processor in communication with an inspection system of a structure to provide inspection results to according to data received from said system, said computer program logic comprising:
a) receiving data that represents actual width of a base portion of the structure;
b) receiving data that represents the distance between the base portion of the structure to a subject crack or flaw located in the structure;
c) receiving the actual width of the structure at location of the subject crack or flaw;
d) receiving location points inputted that represent crack or flaw points and receiving width points inputted that represent width points; and
e) calculating the actual dimensions of the subject crack or flaw based on the relationship between the inputted crack or flaw points and inputted width points as provided in step ‘d’ with the actual pole width of the subject crack or flaw as provided in step ‘c”.

65. The computer program product of claim 64, wherein the inspection results provides crack or flaw information regarding the structure.
